(19) United States
(12) Patent Application Publication
(10) Pub. No.: US 2008/0275917 A1
(43) Pub. Date: Nov. 6, 2008

(54) Itso Fvc2 Application Monitor

(75) Inventors: Barry Sim Hochfield, Glasgow (GB); Anthony Breslin, Glasgow (GB); Stuart Williamson, East Kilbride (GB)

Correspondence Address: FOLEY AND LARDNER LLP;SUITE 500, 3000 K STREET NW, WASHINGTON, DC, 20007, US

(73) Assignee: Ecebs Group Limited

(21) Appl. No.: 11/916,750

(22) PCT Filed: Jun. 6, 2006
(86) PCT No.: PCT/GB06/02078

§ 371 Date: Feb. 19, 2008

(30) Foreign Application Priority Data
Jun. 7, 2005 (GB) 0511599.3

(51) Int. Cl. H04L 17/30; H04L 9/32

(52) U.S. Cl. 707/200; 713/185

(57) ABSTRACT

The invention provides an ITSO-based smartcard system including a programmable smartcard device for use in the ITSO scheme carrying a file system and operating software enabling the on-device file system to interface with at least one off-device ITSO application. At the interface, the off-device ITSO application is permitted to access and/or modify data in the on-device file system. The programmable smartcard device comprises monitoring means operable to monitor the sequence of operations carried out by the off-line application in accessing and/or modifying data in the on-device files and to restrict or prevent further access or modifications to such data if that sequence of operations does not meet predetermined criteria. Preferably, the monitoring means includes a state engine capable of being set to one of a plurality of states, at least one of which is an error state, in which further modification to the data in some or all of the on-device files is prevented until the sequence of operations is restarted. The system may also be such that inter-engagement of the smartcard device with the interface device causes the interface device to generate a session key used in the encryption/decryption of data and/or commands during a sequence of operations carried out to access and/or modify data carried by the programmable smartcard device. Preferably, completion of a sequence of operations to modify data on the programmable smartcard device causes the interface device to open a new session and to generate a second session key and to use that second session key to verify that the required data has been modified in accordance with the intended sequence of operations. The invention is thus capable of providing an ITSO based system with better protection against fraud.

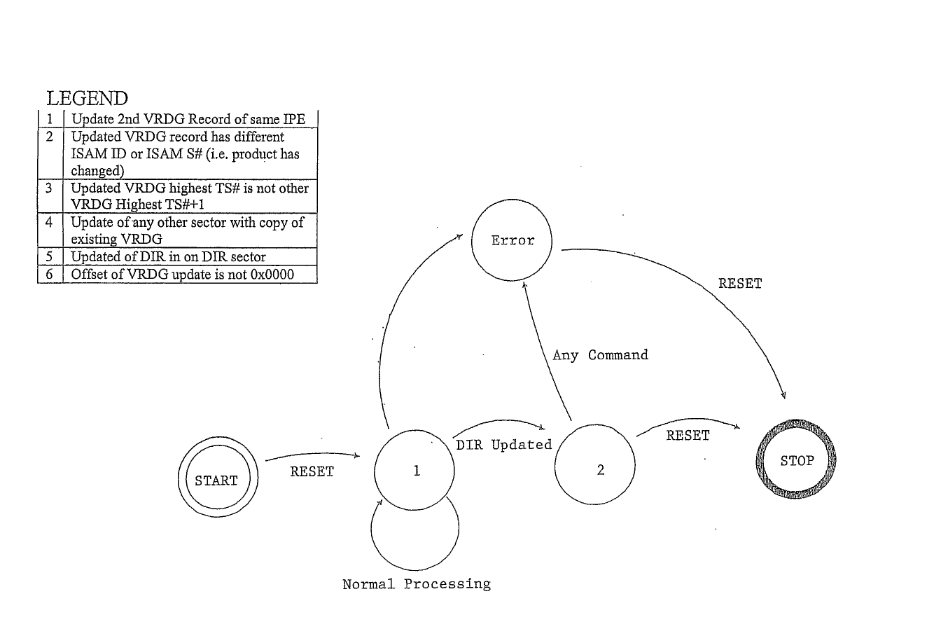

The present invention relates to an improvement to existing ITSO technology, that is, the electronic ticketing scheme proposed by the Interoperable Ticketing Smartcard Organisation standards developed by UK Government and incorporated in European Standard EN 1545, in any of the versions currently available or which become available in future, in particular, Customer Media Definitions—ITSO part 10. CD10 ITSO TS1000-10 2003-11. As will be seen from the description below, the term ‘ticketing scheme’ does not only encompass traditional transportation ticketing operations but any secure scheme in which a ticket, token, voucher, or prescription is validated for redemption against the provision of goods or services. In particular, the present invention relates to a programmable smartcard device for use in an ITSO scheme and carrying a file system and operating software enabling the on-device file system to interface with at least one off-device ITSO application to permit the off-device application to access and/or modify data in the on-device file system.

Existing ITSO schemes operate on the basis that the cards used are no more than simple memory cards. This means that the ‘point of service terminal’ (‘POST’) is free to read and write to the card in any order without any checks or restrictions other than the need to provide appropriate passwords. Although the ITSO specifications also provide for the use of microprocessor cards (‘smartcards’), these have to inter-operate with the POST in much the same way as a memory card, that is, they have to be set up to emulate a memory card. Instead of sectors in the memory card, a smartcard-based system utilises files on the smartcard but the structures and read/write access restrictions are similar.

The ITSO schemes use cryptographically generated seals on data which might, for example, represent access to a service of some kind, or some other commodity of value. The integrity of the data is protected by means of these seals with all processing being done by a Secure Access Module (‘SAM’) in the POST.

Under the existing scheme, ITSO Value products can be used as an “electronic purse” to hold a balance which can be incremented or decremented by an ITSO POST. This is implemented as a Fixed Data Group (FRDG) and, normally, 2 value data groups (VRDGs), one holding the current balance and the other holding the previous copy of the balance. Because the ITSO specification can accommodate lower functioning memory card types such as Mifare Classic, the POST must be involved directly with memory management tasks such as what happens when a transaction is aborted because the card is removed from the POST prematurely. This scenario is known in the industry as “anti-tear”.

Two VRDGs are used for anti-tear purposes to ensure that at least one copy of the VRDG is without errors if the card is “torn” during updating of the VRDG. In normal operation, the POST, when modifying the IPE (‘ITSO Product Entity’—the ITSO term for a “ticket” data set on the Customer media or smartcard) balance, will alternately update the VRDGs in order that one VRDG contains the current copy of the balance and the other the previous copy of the balance. For anti-tear protection there are two entries of the Shell directory. The ‘Shell’ is the ITSO data construct equivalent to a “ticket wallet” containing several IPE's. The current entry will point to the current VRDG and the previous entry will point to the VRDG with previous copy of the balance.

The existing FVC2 Secure Messaging scheme proposed by the standard referred to above supports mutual authentication between the Customer Media (the smartcard) and ISAM (ITSO Secure Application Module—a trusted computer inserted in the POST) to generate a session key. The session key is used to create a Message Authentication Certificate (‘MAC’) (a cryptographically protected HASH of a set of data the integrity of which the MAC ensures) over data read from the smartcard and over the data updated to the smartcard. The session key does not change during the course of the session. For the smartcard or customer media READ command, the smartcard (Customer Media) calculates the MAC over the data returned by the Customer Media, and is verified by the ISAM. There are no security conditions on the selection and reading of files within the FVC2 Customer Media.

For the FVC2 Customer Media UPDATE command, the MAC is calculated over the data of the command only by the ISAM and verified by the Customer Media before internally updating the Customer Media file. In addition to the Secure Messaging applied to the UPDATE command data, each file has a unique password which must be sent to the Customer Media before the UPDATE command completes. As the password is static, the same password is applied in each session.

This scheme allows the POST to determine when the data was read from the Customer Media (smartcard), but it cannot determine whether it was read from the correct file. By starting a new session, and thus generating a new session key the POST can determine whether an update to the Customer Media was successful, but still it cannot verify that it was to the correct file.

In the existing FVC2 Customer Media interface the Customer Media (smartcard) does not test that the data being written is correct, other than verifying the MAC is correct, or that the correct sequence of updates has occurred.

In the existing FVC2 scheme as described in the previous section, with and without Secure Messaging, it is possible for an attacker to read data from the Customer Media (smartcard) and write it back the Customer Media in a different file and by so selecting different files change the file that data is written to by the POST. By exploiting these vulnerabilities the attacker could make multiple copies of an IPE product or copy the updated product to a different file on the Customer Media to be read on update verification of the product by the POST.

These attacks could be used within the ITSO application to stop a modification of a VRDG where the POST has attempted to decrement the balance on the VRDG, i.e. the attacker has changed the location where the updated VRDG is written to on the Customer Media and returned this data when the POST reads back the data. Even if the POST starts a new session to generate a new session key it cannot determine that the data read was stored in the correct file. Similarly the attack could be used to stop the update to the ITSO directory that points to the updated VRDG causing the POST at that next use of the CM to use the previous copy of the VRDG. This is known as a form of “replay attack” and results in a “bottomless purse”.

Thus, the current microprocessor version (FCV2) of the existing ITSO specifications does not protect the smartcard against attacks which involve resequencing the steps of a transaction between the POST and the card.

In accordance with the invention, the programmable smartcard device described above is characterised in that it comprises monitoring means operable to monitor the sequence of operations carried out by the off-line application in accessing and/or modifying data in the on-device files and to restrict or prevent further access or modifications to such data if that sequence of operations does not meet predetermined criteria. Preferably, the monitoring means includes a state engine capable of being set to one of a plurality of states, at least one of which is an error state, in which further modification to the data in some or all of the on-device files is prevented until the sequence of operations is restarted.

The invention may also provide a smartcard scheme including at least one programmable smartcard device carrying a file system and operating software enabling the on-device file system to interface with at least one off-device application at an interface device to permit the off-device application to access and/or modify data in the on-device file system; the system being such that inter-engagement of the smartcard device with the interface device causes the interface device to generate a session key used in the encryption/decryption of data and/or commands during a sequence of operations carried out to access and/or modify data carried by the programmable smartcard device, the scheme being characterised in that completion of a sequence of operations to modify data on the programmable smartcard device causes the interface device to open a new session and to generate a second session key and to use that second session key to verify that the required data has been modified in accordance with the intended sequence of operations.

The threats to the security of the ITSO scheme referred to above can be countered, in accordance with preferred embodiments of the invention, by monitoring updates to the FVC2 Customer Media (the smartcard), to ensure data written to the Customer Media has correct content and destination. It is also proposed that the FVC2 Customer Media, rather than simply allowing data to be written to any file if the correct password and MAC are provided, enforces the relevant ITSO application processing rules preventing the attacks detailed above. Thus, the invention may enable implementations of ITSO compatible cards and terminals enhanced such that they are secure enough to be used as a nationally deployable electronic purse.

An embodiment of the invention will now be described in detail, by way of example, with reference to the drawing which is a schematic diagram representing a state machine by means of which the invention can be brought into effect.

The invention only concerns modification of ITSO Value products. It is based on the processing rules specified in Customer Media Definitions—ITSO part 10. CD10 ITSO TS1000-10 2003-11. In the invention, the FVC2 Customer Media, which may, for example, be a smartcard or the like, will implement the following processing and data monitoring checks during normal processing.

### State 1

Within state 1, the FVC2 Customer Media will monitor the incoming update commands and change state to Error if any of the following tests fail.
Tests that only one update of one of the VRDG data groups within the IPE occurs. This will ensure an attacker cannot make multiple updates, i.e. restore the original contents of the VRDG. This does not affect the creation of IPEs where both VRDGs are written to the Customer Media as the IPE will not exist in the directory sector chain table or proprietary file and hence will not be monitored by the Customer Media.
Tests that the updated VRDG is the same IPE product by verifying the VRDG ISAM ID and ISAM S#. This is to ensure the VRDG is not overwritten by another VRDG for another IPE product.
Tests that the updated VRDG is not overwritten by the IPE fixed data group (FRDG).
Tests the offset of the VRDG update is 0x0000.
Tests that the highest value sequence number (TS#) in the updated VRDG is equal to the highest TS# in the other VRDG+1. This rule is correct for normal operation and recovery from an anti-tear situation. It will ensure that the previous copy of the VRDG is not being restored and ensures the VRDG is not being overwritten using a copy of the other VRDG.
Tests that no other files are updated with a VRDG, where a VRDG should not be stored. This can be achieved by interpreting the directory sector chain table to determine which files should have VRDGs or read data from a proprietary file or element that specifies the location of the VRDGs on the Customer Media. This ensures an attacker cannot make temporary copies of VRDGs to pass the verification tests.
Tests that the updated directory is only written to one of the last 2 files on the Customer Media reserved for the directory copies. This ensures an attacker cannot make temporary copies of the directory to pass the verification tests.
Tests that only directory copies are updated in the reserved directory files. This ensures the attacker cannot corrupt the directory with an IPE data group.

### State 2

Within the ITSO scheme normal processing, only one update of the directory is performed. An update of the directory will change the internal FVC2 Customer Media state to 2. Within state 2, the FVC2 will not allow any other commands to be successfully executed.

### Error State

Within the Error state the FVC2 Customer Media will not allow any further updates to the Customer Media until the Customer Media is reset.

Furthermore, in the existing ITSO FVC2 Secure Messaging scheme it is not possible for a POST to confirm that the data it requested to be written to the FVC2 Customer Media was actually updated in the Customer Media as the response to the Update operation does not include any Secure Messaging verification data from the FVC2 Customer Media. The response to the Update operation only includes status bytes which an attacker could generate and return to the POST. Further, a POST cannot determine if the update command sent to the FVC2 Customer Media was sent to the correct file or modified to update a different offset in the intended file. In the existing FVC2 Secure Messaging scheme an attacker could stop an update to a file which was decrementing a value, update the file with the previous contents of the file at the start of the session or corrupt the file by writing the data to an incorrect location in the correct file on the FVC2 Customer Media. In the latter case, the attacker would corrupt the copy of the ITSO product, causing the ITSO application to revert to an older copy of the ITSO product on the FVC2 Customer Media as part of the normal operation of the ITSO anti-tear scheme.

By reading back the data after an UPDATE command a POST can use the ISAM to verify the data was read from the FVC2 Customer Media. However, as the both the READ and UPDATE commands only calculate the MAC over the command data, the MAC returned from a read of the same offset will be the same MAC contained within the corresponding UPDATE command, therefore the POST cannot determine if the data was updated or it simply received the MAC it generated.

To overcome this, it is proposed that a second secure session is started after updating of the FVC2 Customer Media within the session. This second Secure Messaging session will generate a new Secure Messaging session key. The POST can perform a read of the data it requested to be updated on the FVC2 Customer Media to verify the data was written to the correct offset with the correct file. Where the POST has not updated the entire Data Group it must ensure that read verification contains a sufficient data range of the Data Group to ensure that an attacker has not changed the offset in the update of the Data Group to corrupt or modify the Data Group.

Thus, the invention provides techniques which can be implemented to allow FVC2 Customer Media, conventionally operating in a less secure environment, to be utilised in a manner sufficiently secure to function as a nationally deployable electronic purse scheme.

1. A programmable smartcard device for use in an ITSO scheme and carrying a file system and operating software enabling the on-device file system to interface with at least one off-device ITSO application to permit the off-device ITSO application to access and/or modify data in the on-device file system; the programmable smartcard device being characterised in that it comprises monitoring means operable to monitor the sequence of operations carried out by the off-line application in accessing and/or modifying data in the on-device files and to restrict or prevent further access or modifications to such data if that sequence of operations does not meet predetermined criteria.

2. A device according to claim 1 wherein the monitoring means includes a state engine capable of being set to one of a plurality of states, at least one of which is an error state, in which further modification to the data in some or all of the on-device files is prevented until the sequence of operations is restarted.

3. A programmable smartcard device according to claim 2, the state engine being such that it is set to the said error state when the monitoring means determines that more than one update of one of the value data groups within the same ITSO product entity has occurred.

4. A device according to claim 2, the state engine being such that it is set to the said error state when the monitoring means determines that an updated value data group is not associated with the correct ITSO product entity by verifying the value data group ISAM ID and ISAM S#.

5. A device according to claim 2, the state engine being such that it is set to the said error state when the monitoring means determines that the updated value data group has been overwritten by the fixed data group associated with the ITSO product entity.

6. A device according to claim 2, the state engine being such that it is set to the said error state when the monitoring means determines that the offset of the value data group update is not 0x0000.

7. A device according to claim 2, the state engine being such that it is set to the said error state when the monitoring means determines that the highest value sequence number in the updated value data group is one more than the highest value sequence number of the other value data group associated with the same ITSO product entity.

8. A device according to claim 2, the state engine being such that it is set to the said error state when the monitoring means determines that a value data group has been updated to a file where a VRDG should not be stored.

9. A device according to claim 2, the state engine being such that it is set to the said error state when the monitoring means determines that an updated directory is written to a file other than one of the last two files on the device reserved for directory copies.

10. A device according to claim 2, the state engine being such that it is set to the said error state when the monitoring means determines that a directory copy has been updated in a file other than a reserved directory files.

11. An ITSO smartcard scheme including at least one programmable smartcard device carrying a file system and operating software enabling the on-device file system to interface with at least one off-device ITSO application at an interface device to permit the off-device ITSO application to access and/or modify data in the on-device file system; the system being such that inter-engagement of the smartcard device with the interface device causes the interface device to generate a session key used in the encryption/decryption of data and/or commands during a sequence of operations carried out to access and/or modify data carried by the programmable smartcard device, the scheme being characterised in that completion of a sequence of operations to modify data on the programmable smartcard device causes the interface device to open a new session and to generate a second session key and to use that second session key to verify that the required data has been modified in accordance with the intended sequence of operations.

12. A scheme according to claim 11 wherein the programmable smartcard device is a device for use in an ITSO scheme and carrying a file system and operating software enabling the on-device file system to interface with at least one off-device ITSO application to permit the off-device ITSO application to access and/or modify data in the on-device file system; the programmable smartcard device being characterised in that it comprises monitoring means operable to monitor the sequence of operations carried out by the off-line application in accessing and/or modifying data in the on-device files and to restrict or prevent further access or modifications to such data if that sequence of operations does not meet predetermined criteria.
